(19) United States
(12) Patent Application Publication
(10) Pub. No.: US 2026/0004627 A1
(43) Pub. Date: Jan. 1, 2026

(54) MONEY STORAGE DEVICE AND MONEY PROCESSING DEVICE

(71) Applicant: GLORY LTD., Himeji-shi (JP)

(72) Inventors: Akira OKUDA, Himeji-shi (JP); Yoichi TAKEMURA, Himeji-shi (JP); Yuji SHIMODAIRA, Himeji-shi (JP)

(73) Assignee: GLORY LTD., Himeji-shi (JP)

(21) Appl. No.: 19/318,423

(22) Filed: Sep. 4, 2025

Related U.S. Application Data
(63) Continuation of application No. PCT/JP2024/007135, filed on Feb. 27, 2024.

(30) Foreign Application Priority Data
Mar. 9, 2023 (JP) 2023-036585

(51) Int. Cl. G07D 11/125; E05B 65/46; G07D 11/18

(52) U.S. Cl. CPC G07D 11/125; G07D 11/18; E05B 65/461

(57) ABSTRACT

A money storage device includes: a storage; a base that supports the storage; a switch that switches between connection and disconnection between the storage and the base; and a first restrictor that restricts detachment of the storage from the base with the storage connected to the base and to release restriction of the detachment of the storage in a case where the switch disconnects the storage and the base from each other.

### CROSS-REFERENCE TO RELATED APPLICATIONS

This application is a bypass continuation of International Patent Cooperation Treaty Application No. PCT/JP2024/007135 filed on Feb. 27, 2024, and Japanese Patent Application No. 2023-036585 filed on Mar. 9, 2023, the entire disclosures of each are incorporated herein by reference.

### BACKGROUND

A conventional banknote handling device includes a storage that includes a cassette and that is housed in a safe. The cassette stores a plurality of banknotes horizontally arranged while being stood with a long edge of each banknote oriented downward. The cassette can be pulled out of an opening of the safe by being moved in a horizontal direction.

### SUMMARY

The technique disclosed herein relates to a money storage device. The money storage device includes: a storage that stores money; a base to which the storage is connected and that supports the storage while being connected to the storage; a switch that switches between connection and disconnection between the storage and the base; and a first restrictor that restricts detachment of the storage from the base with the storage connected to the base and that releases restriction of the detachment of the storage in a case where the switch disconnects the storage and the base from each other.

### BRIEF DESCRIPTION OF THE DRAWINGS

FIG. 1 illustrates an external appearance of a money handling device.

FIG. 2 illustrates an internal structure of the money handling device.

FIG. 3 is a block diagram of the money handling device.

FIG. 4 illustrates an internal structure of a collection unit.

FIG. 5 is a plan view of the collection unit.

FIG. 6 is a plan view of a switch.

FIG. 7 is a side view of the switch.

FIG. 8 illustrates a first restrictor.

FIG. 9 illustrates locking/unlocking between a cover and a link member.

FIG. 10 illustrates a procedure of detaching a collection cassette.

FIG. 11 shows a control procedure related to detachment of the collection cassette.

FIG. 12A shows an exemplary screen displayed on an interface unit.

FIG. 12B shows an exemplary screen displayed on the interface unit.

### DESCRIPTION OF EMBODIMENTS

The conventional banknote handling device has a structure that allows the storage to be detached from the device only by being moved in one direction. Unlike the conventional structure, a structure may be conceived in which the storage is connected to a specific member of the device, and disconnection of the storage is required when the storage is to be detached from the device. In this structure, if, when the storage is to be detached, an operator attempts to detach the storage from the device without disconnecting the storage, the storage and/or the member of the device may be damaged. Detachment of the storage requires a structure that enables the detachment through an appropriate procedure.

The technique disclosed herein guarantees that a storage is detached through an appropriate procedure.

The technique disclosed herein relates to a money storage device. The money storage device includes: a storage that stores money; a base to which the storage is connected and that supports the storage while being connected to the storage; a switch that switches between connection and disconnection between the storage and the base; and a first restrictor that restricts detachment of the storage from the base with the storage connected to the base and that releases restriction of the detachment of the storage in a case where the switch disconnects the storage and the base from each other.

The storage stores money. The money is banknotes or coins. The base supports the storage. The base and the storage are mechanically and/or electrically connected to each other. The mechanical connection mainly means that a portion of the base and a portion of the storage are engaged with each other. The electrical connection mainly means that the base and the storage are connected to each other via a terminal, for example. The terminal is used to transmit and receive a signal and/or to supply power, for example. However, the connection between the base and the storage is not limited to these examples, and may include various forms that provide a specific function.

For example, as will be described later, a second opening of a transport unit on the base is connected to a first opening of the storage. The first opening and the second opening are mechanically connected to each other.

Since the base and the storage are connected to each other, detaching the storage from the base without disconnecting the storage from the base may cause damage to the base and/or the storage. The first restrictor restricts detachment of the storage from the base. Even if the operator performs a misoperation in which the storage is attempted to be detached without disconnecting the storage, the storage cannot be detached. Damage to the base and/or the storage is reduced.

The switch disconnects the storage from the base. The first restrictor releases the restriction of detachment of the storage when the switch disconnects the storage and the base from each other. When the operator is to detach the storage, the base and the storage are not connected to each other. When the storage is to be detached, damage to the base and/or storage is reduced. The money storage device can guarantee that the storage is detached through an appropriate procedure.

The storage may have a first opening through which money passes, the base may include a transport unit that sends money to the storage through a second opening of the transport unit connected to the first opening, and the switch may switch between connection and disconnection between the first opening and the second opening.

In a state where the first opening of the storage is connected to the second opening of the transport unit, money can be sent to the storage. In a state where the first opening of the storage is connected to the second opening of the transport unit, detachment of the storage may cause damage to the first opening and/or the second opening.

When the storage is to be detached, the switch disconnects the first opening and the second opening from each other. Damage to the first opening and/or the second opening is reduced.

The transport unit may send money between the first opening and the second opening in a first direction, and the switch switches from the connection to the disconnection by relatively moving at least one of the storage or the transport unit so that the storage and the transport unit are apart from each other in the first direction.

The storage and the transport unit approaching each other in the first direction allow the first opening and the second opening to be connected to each other, and the storage and the transport unit moving away from each other in the first direction allow the first opening and the second opening to be disconnected from each other. The operator can distinguish connection between the first opening and the second opening from disconnection therebetween based on the relative positions of the storage and the transport unit. The operator can detach the storage through a correct procedure.

The switch may include a second restrictor that restricts movement of the storage to prevent the storage and the transport unit connected to each other from being apart from each other in the first direction.

The second restrictor maintains the storage and the transport unit connected to each other. The transport unit can stably send money to the storage. The second restrictor may include an engaging member that engages with the storage and/or the transport unit as will be described later. If the second restrictor engages with the storage and/or the transport unit, the second restrictor restricts the movement of the storage and/or the transport unit. The storage and the transport unit connected to each other are maintained. If the second restrictor is disengaged from the storage and/or the transport unit, the movement of the storage and/or the transport unit is not restricted. The storage and the transport unit can be disconnected from each other.

The second restrictor may include a lock mechanism that releases restriction of the movement of the storage in a case where a signal is received from a controller.

Releasing the restriction of the movement of the storage enables disconnection of the storage. Thus, the storage can be detached from the base. The lock mechanism of the second restrictor switches between its locked state and its unlocked state in response to the signal from the controller. Unless the lock mechanism is unlocked, the storage cannot move. Thus, the operator cannot detach the storage. The lock mechanism of the second restrictor enables optimization of the procedure for detaching the storage, and allows high security of the money storage device to be ensured.

The second restrictor may include an engaging member that engages directly or indirectly with the storage, and a lever that disengages the engaging member, the lever being manually handled, and the lock mechanism may restrict handling of the lever, and may allow handling of the lever in a case where a signal is received from the controller.

The operator can disengage the engaging member by handling the lever. Disengagement of the engaging member allows the storage to move away from the transport unit. Thus, the storage and the transport unit can be disconnected from each other.

The lock mechanism restricts handling of the lever. Since the operator cannot handle the lever, the storage and the transport unit cannot be disconnected from each other. Since the storage cannot be detached, the lock mechanism allows security of the money storage device to be ensured. If unlocking allows handling of the lever, the storage and the transport unit can be disconnected from each other. The operator can detach the storage. The operator can detach the storage from the base through the correct procedure.

The lock mechanism may restrict disengagement of the engaging member instead of restricting handling of the lever. Alternatively, the lever of the second restrictor may be omitted, and the engaging member may switch between its engaged state and its disengaged state in response to the signal from the controller.

Various forms of the engaging member may be adopted. The engaging member may be a hook that engages with the storage or a frame holding the storage. The engaging member may be a protrusion that engages with the storage or the frame holding the storage.

The switch may move the storage between a first position in which the storage and the base are connected to each other and a second position in which the storage and the base are disconnected from each other, and the first restrictor may restrict the detachment of the storage from the base in a state where the storage is located in the first position, and allows the detachment of the storage from the base in a state where the storage is located in the second position.

The first restrictor switches between the restriction and allowance of detachment of the storage in response to the position of the storage. The connection/disconnection of the storage is linked with the restriction/allowance of detachment of the storage. The operator can check the position of the storage to determine whether or not the storage can be detached. The storage is reliably detached through the correct procedure.

The first position may be the position in which the storage and the location of connection between the storage and the base is close to each other, and the second position may be the position in which the storage and the location of connection is apart from each other. The storage may be close to, or apart from, the location of connection (e.g., the above-described transport unit) in the first direction.

The first restrictor may include a cover that restricts the detachment of the storage in a closed state by covering at least one portion of the storage, and that allows the detachment of the storage in an open state by opening the storage.

The cover can effectively restrict the detachment of the storage performed by the operator. Misoperations performed by the operator are reduced. In addition, the cover directly restricting the detachment of the storage allows high security of the money storage device to be ensured. The storage may be attached to and detached from the base in a second direction orthogonal to the direction of movement between the first position and the second position. The cover in the closed state may be positioned adjacent to the storage in the second direction, and may interfere with the storage that is about to move in the second direction, thereby restricting detachment of the storage. The cover shifting to the open state may move away from its position adjacent to the storage in the second direction, and may allow the storage to move in the second direction.

The first restrictor may include a link that links a position of the storage with opening/closing of the cover.

If the storage moving between the first position and the second position causes switching to be performed between connection and disconnection of the storage, the link links the switching with the restriction/allowance of detachment of the storage. Misoperations performed by the operator to detach the storage are reduced.

The cover may include a locking portion in which the link is locked, a shift from the closed state to the open state of the cover may be restricted in a state where the link is locked in the cover, and the shift from the closed state to the open state may be allowed in a state where the link is not locked in the cover, and in a case where the storage is located in the first position, the link may be locked in the locking portion, and in a case where the storage has moved to the second position, the storage moving relative to the cover may prevent the link from being locked in the locking portion.

Since switching is performed between mechanical locking and unlocking between the link and the cover, the operator cannot shift the cover to the open state with the link locked in the cover. The operator can shift the cover to the open state with the link prevented from being locked in the cover. The first restrictor can effectively restrict detachment of the storage resulting from the operator's misoperations.

The money storage device may further include: a third restrictor that allows connection between the storage and the base in a case where the first restrictor restricts the detachment of the storage and that restricts the connection in a case where the first restrictor does not restrict the detachment of the storage.

When the operator is to attach the storage to the base, the third restrictor imposes restrictions so that the storage can be correctly attached. That is to say, if the first restrictor does not restrict the detachment of the storage, the operator cannot connect the storage to the base. If the first restrictor restricts the detachment of the storage, the operator can connect the storage to the base. Since the third restrictor guarantees that the storage is correctly attached to the base, the detachment of the storage is restricted in a state where the storage and the base are connected to each other as described above.

In a case where the first restrictor restricts the detachment of the storage, the third restrictor may engage with the first restrictor to allow movement of the storage in a direction in which the storage is connected to the base, and in a case where the first restrictor does not restrict the detachment of the storage, the third restrictor may be prevented from engaging with the first restrictor to restrict the movement of the storage.

When the storage is to be attached, the third restrictor and the first restrictor are linked with each other. This link enables correct attachment of the storage.

The technique disclosed herein relates to a money handling device. This money handling device includes: a transport unit that transports money; a money storage device that stores money transported by the transport unit; a controller that outputs a control signal to the transport unit and the money storage device; and a housing that houses the money storage device such that the money storage device can be pulled out of the housing. The money storage device includes: a storage that stores money; a base that is connected to the storage and supports the storage while being connected to the storage; a switch that switches between connection and disconnection between the storage and the base; and a restrictor that restricts detachment of the storage from the base with the storage connected to the base and that releases restriction of the detachment of the storage in a case where the switch disconnects the storage and the base from each other.

As described above, the money storage device and the money handling device can guarantee that the storage is detached through the appropriate procedure.

The money storage device may include: a first opening through which the money transported by the transport unit passes; a shutter that shields the first opening; a first lock that restricts pulling of the money storage device out of the housing; and a second lock that restricts switching made by the switch, and in a case where the controller receives an instruction signal indicating detachment of the storage, the controller may close the shutter to shield the first opening, and may output a release signal to the first lock and the second lock.

For example, if, when the money stored in the storage is to be collected, the operator issues an instruction to detach the storage through an operation of input into an operation unit, the controller closes the shutter to shield the first opening, and outputs the release signal to the first lock and the second lock. The operator can pull the money storage device out of the device housing, and can detach the disconnected storage through switching performed by the switch from the base.

If an instruction is issued to detach the storage, the first opening of the storage is closed. Access into the storage detached from the base is blocked, thereby allowing high security of the storage to be ensured. In addition, the first opening closed can reduce the exit of the money from the first opening of the storage detached from the base.

When the device recovers after occurrence of money transport error, the controller may individually receive a release instruction signal for the first lock and a release instruction signal for the second lock, may output a release signal to the first lock upon receiving the release instruction signal for the first lock, and may output a release signal to the second lock upon receiving the release instruction signal for the second lock.

The device in which the transport error has occurred is generally recovered by the operator who has special authority and who has known the recovery procedure. The operator individually issues an instruction to unlock the first lock and an instruction to unlock the second lock in accordance with a condition of the transport error and a recovery procedure corresponding to the condition through the operation of input into the operation unit. The controller individually receives the release instruction signal for the first lock and the release instruction signal for the second lock. The controller outputs the release signal to the first lock and/or to the second lock based on the release instruction signal for the first lock and/or the release instruction signal for the second lock. This allows the operator to unlock only the lock(s) required to be unlocked. Thus, the device can be smoothly recovered without misoperations. The controller may instruct the operation unit to perform display for individually issuing an instruction to unlock the first lock and an instruction to unlock the second lock. If the operator has special authority, an instruction may be issued to perform the display based on input from the operator into the operation unit. If no transport error has occurred, the display may be prevented. Alternatively, if no transport error has occurred, individual instructions to unlock the corresponding locks may be prevented from being accepted.

When the device in which the transport error has occurred is to be recovered, the opening of the storage does not have to be closed. The reason for this is that, for example, money around the opening may be removed for the purpose of recovery. Since the operator who performs recovery has special authority, security is maintained even if the storage left open is detached from the base.

Embodiments of a money storage device and a money handling device will be described below with reference to the drawings. The money storage device and the money handling device described here are examples.

### (Overall Structure of Money Handling Device)

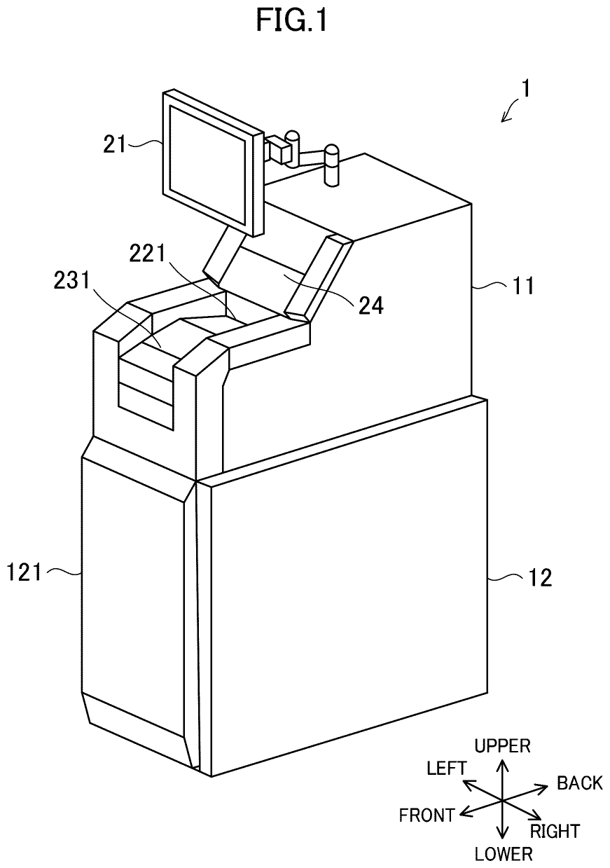

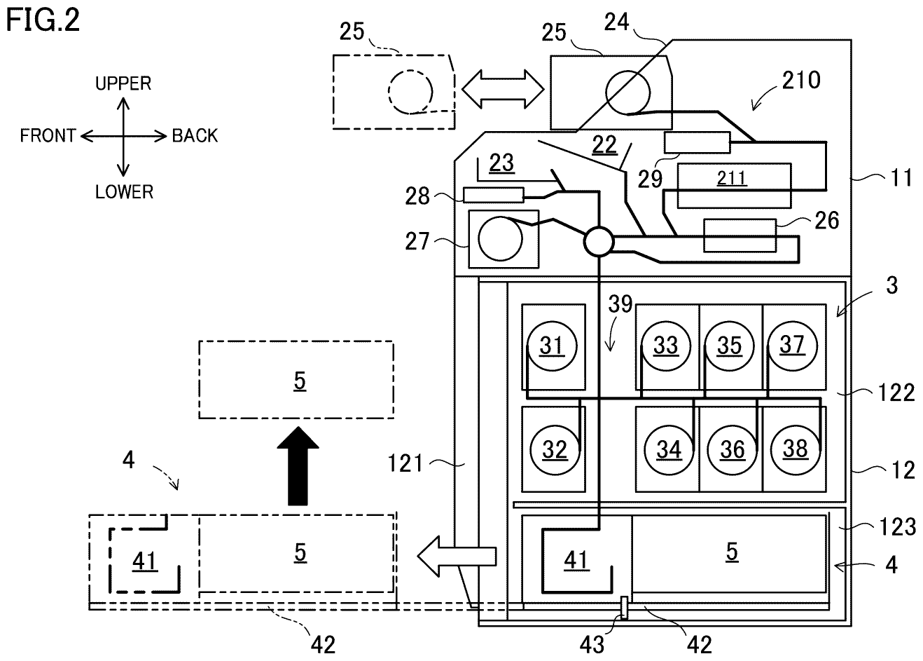

FIG. 1 illustrates an external appearance of a money handling device 1. FIG. 2 schematically illustrates an internal structure of the money handling device 1. The money handling device 1 performs processes related to banknotes. The money handling device 1 performs a depositing process of banknotes and/or a dispensing process of banknotes. The money handling device 1 is installed in a back office of a store, such as a retail store. The money handling device 1 may be installed in a financial institution, such as a bank.

In the following description, the front left side of the sheet of FIG. 1 may be referred to as a “front side,” and the right back side of the sheet may be referred to as a “back side.” The front side of the money handling device 1 is a side thereof on which a user is located when using the money handling device 1, and the back side of the money handling device 1 is a side thereof opposite to the front side. The left back side of the sheet of FIG. 1 may be referred to as a “left side,” and the front right side of the sheet may be referred to as a “right side.” The left side of the money handling device 1 is the left side thereof with respect to the user who uses the money handling device 1, and the right side of the money handling device 1 is a side thereof opposite to the left side. The front, back, left, right, upper, and lower sides in the following description do not limit the structure of the money handling device 1.

The money handling device 1 includes an upper housing 11. The money handling device 1 includes a lower housing 12. The lower housing 12 is located on the lower side of the upper housing 11. The lower housing 12 has a structure of a safe. As illustrated in FIG. 2, the lower housing 12 is divided into a first region 122 and a second region 123.

The lower housing 12 includes a door 121. In the example in FIG. 1 or 2, the door 121 is located in front of the lower housing 12. The position of the door 121 is not limited to the front side of the lower housing 12. When the door 121 opens, the inside of the lower housing 12 is opened. The door 121 has a lock. The lock is a cylinder lock or an electronic lock. Opening of the door 121 means opening of the safe. A person who has special authority, such as a manager, can open the door 121.

The money handling device 1 includes an interface unit 21. The interface unit 21 provides various types of information to the user of the money handling device 1, and accepts various input operations performed by the user. The interface unit 21 is an exemplary operation unit. In FIG. 1, the interface unit 21 is a flat panel display having a touch function. The flat panel display is attached to an upper surface of the upper housing 11 via a support arm. The interface unit 21 is not limited to a flat panel display having a touch function.

The interface unit 21 may also be a receiver that receives signals from an external device. The user operating an external operating device causes the external device to transmit a signal to the interface unit 21, and causes the interface unit 21 to receive the signal.

The interface unit 21 with any structure outputs a signal corresponding to the user's operation to an upper central processing unit (CPU) 20, which will be described later.

The money handling device 1 includes a depositing unit 22. The depositing unit 22 has an inlet 221. The inlet 221 is open in the upper housing 11. The user inserts banknotes to be deposited into the inlet 221. The depositing unit 22 sends the inserted banknotes out of the inlet 221 into the upper housing 11 one by one.

The money handling device 1 includes a dispensing unit 23. The dispensing unit 23 has an outlet 231. The outlet 231 is open in the upper housing 11. The banknotes to be dispensed are transferred to the outlet 231. The user can manually take the banknotes transferred to the outlet 231 out of the outlet 231.

The money handling device 1 includes a cassette mounting unit 24. As illustrated in FIG. 2, the cassette mounting unit 24 is provided in the upper housing 11, and has a structure to which a mounted cassette 25 is detachably mounted. The mounted cassette 25 stores banknotes, and feeds the stored banknotes. The mounted cassette 25 may be used for the depositing process and/or the dispensing process. The depositing process as used herein is a depositing process in which banknotes are stored in a safe in a broad sense, and the dispensing process is a dispensing process in which banknotes in the safe are transferred to the outside of the device in a broad sense.

The money handling device 1 includes a recognition unit 26. The recognition unit 26 recognizes the banknotes to be handled by the money handling device 1. The recognition unit 26 recognizes at least the denomination, authenticity, and fitness of each of the banknotes, and outputs a recognition signal of the banknote.

The money handling device 1 includes a temporary storage unit 27. The temporary storage unit 27 temporarily stores the banknotes deposited in the depositing process, for example. The temporary storage unit 27 may be, for example, a wind-up storage unit that winds the banknotes around a drum together with a tape.

The money handling device 1 includes a first reject unit 28 and a second reject unit 29. These reject units 28 and 29 store the banknotes determined by the recognition unit 26 to be rejected banknotes.

The money handling device 1 includes a first transport unit 210. The first transport unit 210 is located inside the upper housing 11. The first transport unit 210 has a transport path. The transport path is a combination of rollers, belts, a motor for driving them, and guides. In FIG. 2, the transport path is indicated by thick solid lines. The transport path connects the depositing unit 22, the dispensing unit 23, the cassette mounting unit 24, the recognition unit 26, the temporary storage unit 27, the first reject unit 28, and the second reject unit 29 described above together. The banknotes are transported along the transport path.

A direction changing unit 211 is located partway along the transport path of the first transport unit 210. The direction changing unit 211 changes the orientation of the banknotes being transported between the cassette mounting unit 24 and the recognition unit 26. The orientation of each banknote is changed between the orientation in which a long edge thereof faces forward and the orientation in which a short edge thereof faces forward.

The money handling device 1 includes a storing unit 3. The storing unit 3 includes first to eighth storage cassettes 31 to 38. The first to eighth storage cassettes 31 to 38 are located in the first region 122 of the lower housing 12. The first to eighth storage cassettes 31 to 38 store banknotes, and feed the stored banknotes. The first to eighth storage cassettes 31 to 38 are, for example, wind-up storage cassettes. The first to eighth storage cassettes 31 to 38 may be stack-type storage cassettes that store banknotes in a stacked manner. The denomination of the banknotes stored in each of the first to eighth storage cassettes 31 to 38 is determined in advance.

The money handling device 1 includes a second transport unit 39. The second transport unit 39 is located inside the first region 122 of the lower housing 12. The second transport unit 39 has a transport path. The transport path of the second transport unit 39 is connected to the transport path of the first transport unit 210, and connects the first to eighth storage cassettes 31 to 38 described above together.

The money handling device 1 includes a collection unit 4. The collection unit 4 is an exemplary money storage device. The collection unit 4 is located in the second region 123 of the lower housing 12. The collection unit 4 includes a collection cassette 5 that can be mounted thereinto. The collection cassette 5 is an exemplary storage. The collection cassette 5 is used in a collection process. The collection process is the process of collecting the banknotes stored in the first to eighth storage cassettes 31 to 38 from the money handling device 1. The structure of the collection cassette 5 will be described in detail later.

The collection unit 4 also includes a third transport unit 41. The third transport unit 41 is located inside the second region 123 of the lower housing 12. The third transport unit 41 is connected to the transport paths of the first transport unit 210 and the second transport unit 39. The third transport unit 41 is connected also to the collection cassette 5. The third transport unit 41 sends the banknotes to the collection cassette 5. The structure of the third transport unit 41 will be described in detail later.

The collection cassette 5 is detachably mounted to the money handling device 1. More specifically, the collection unit 4 includes a base 42 as illustrated in FIG. 2. The collection cassette 5 is detachably mounted to the base 42. The third transport unit 41 is fixed on the base 42.

In a state where the door 121 of the lower housing 12 is opened to open the second region 123, a manager can pull the base 42 out of the second region 123 (see the hollow arrow in FIG. 2). In the example in FIG. 2, the base 42 is pulled out to the front of the money handling device 1. The third transport unit 41 and the collection cassette 5 are pulled out of the second region 123 together with the base 42.

After the base 42 has been pulled out of the second region 123, the manager can detach the collection cassette 5 from the base 42 by lifting the collection cassette 5 (see the solid arrow in FIG. 2).

If the collection cassette 5 is to be mounted to the money handling device 1, the manager attaches the collection cassette 5 to the base 42 by lowering the collection cassette 5 from above reversely to the detachment process. Thereafter, the manager can push the base 42 into the second region 123 of the lower housing 12 to house the third transport unit 41 and the collection cassette 5 in the second region 123 together with the base 42. The structure of mounting of the collection cassette 5 to the base 42 will be described in detail later.

The collection unit 4 includes a first electromagnetic lock 43. The first electromagnetic lock 43 is a lock mechanism that engages with the base 42 to restrict the pulling of the base 42. The first electromagnetic lock 43 is unlocked upon receipt of a release signal from the collection unit CPU 40, which will be described later. Unlocking the first electromagnetic lock 43 enables pulling of the base 42.

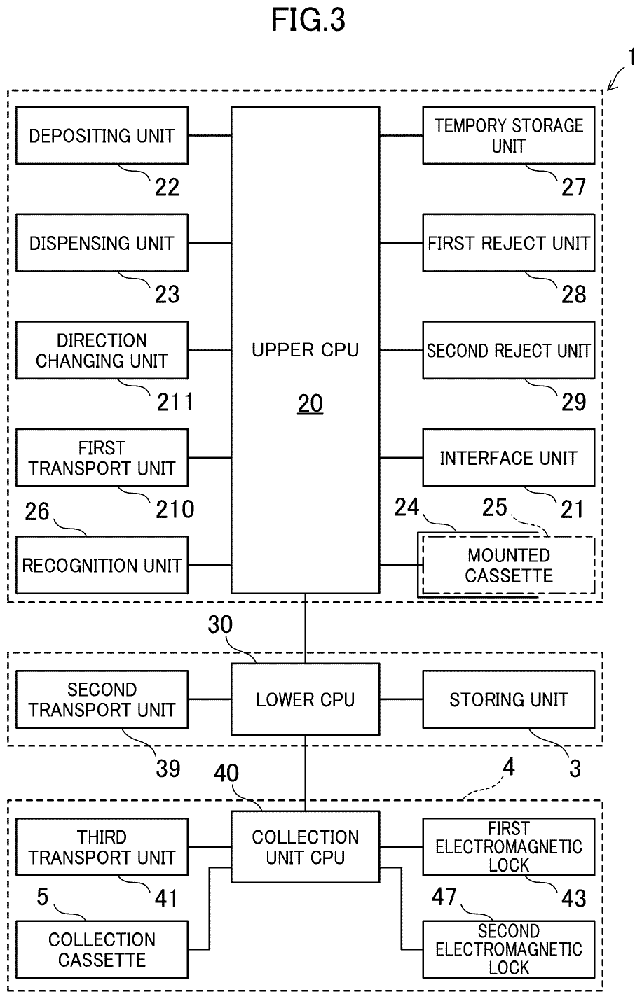

FIG. 3 is a block diagram illustrating a structure associated with control over the money handling device 1. The money handling device 1 includes the upper central processing unit (CPU) 20. The interface unit 21, the depositing unit 22, the dispensing unit 23, the cassette mounting unit 24, the recognition unit 26, the temporary storage unit 27, the first reject unit 28, the second reject unit 29, the first transport unit 210, and the direction changing unit 211 are electrically connected to the upper CPU 20. The upper CPU 20 can output a control signal to each of the interface unit 21, the depositing unit 22, the dispensing unit 23, the cassette mounting unit 24, the recognition unit 26, the temporary storage unit 27, the first reject unit 28, the second reject unit 29, the first transport unit 210, and the direction changing unit 211.

The money handling device 1 includes a lower CPU 30. The upper CPU 20, the storing unit 3, and the second transport unit 39 are electrically connected to the lower CPU 30. The lower CPU 30 can output a control signal to each of the storing unit 3 and the second transport unit 39.

The money handling device 1 includes a collection unit CPU 40. The upper CPU 20, the lower CPU 30, the third transport unit 41, the collection cassette 5, and the first electromagnetic lock 43 are electrically connected to the collection unit CPU 40. A second electromagnetic lock 47 is also electrically connected to the collection unit CPU 40. Although will be described in detail later, the second electromagnetic lock 47 is a lock mechanism that restricts the detachment of the collection cassette 5 from the base 42. The collection unit CPU 40 can output a control signal to each of the third transport unit 41, the collection cassette 5, the first electromagnetic lock 43, and the second electromagnetic lock 47. The upper CPU 20, the lower CPU 30, and/or the collection unit CPU 40 are exemplary controllers. The upper CPU 20, the lower CPU 30, and/or the collection unit CPU 40 develop(s) and execute(s) a corresponding program previously stored in a memory to control the components, thereby achieving the functions and actions of the money handling device 1.

The money handling device 1 executes various processes in response to the user's operation and input through the interface unit 21. Specifically, if the user issues an instruction to execute the depositing process through the interface unit 21, the money handling device 1 executes the process of storing, in the first to eighth storage cassettes 31 to 38, banknotes inserted into the depositing unit 22 or banknotes in the mounted cassette 25. If the user issues an instruction to execute the dispensing process through the interface unit 21, the money handling device 1 executes the process of transferring the banknotes stored in the first to eighth storage cassettes 31 to 38 to the dispensing unit 23 or the process of storing the banknotes in the mounted cassette 25.

In addition, if the user issues an instruction to execute the collection process through the interface unit 21, the money handling device 1 executes the process of storing, in the collection cassette 5, the banknotes stored in any one or more of the first to eighth storage cassettes 31 to 38. After the banknotes have been stored in the collection cassette 5, the collection cassette 5 is detached from the money handling device 1. The procedure of detaching the collection cassette 5 will be described later.

### (Structure of Collection Unit)

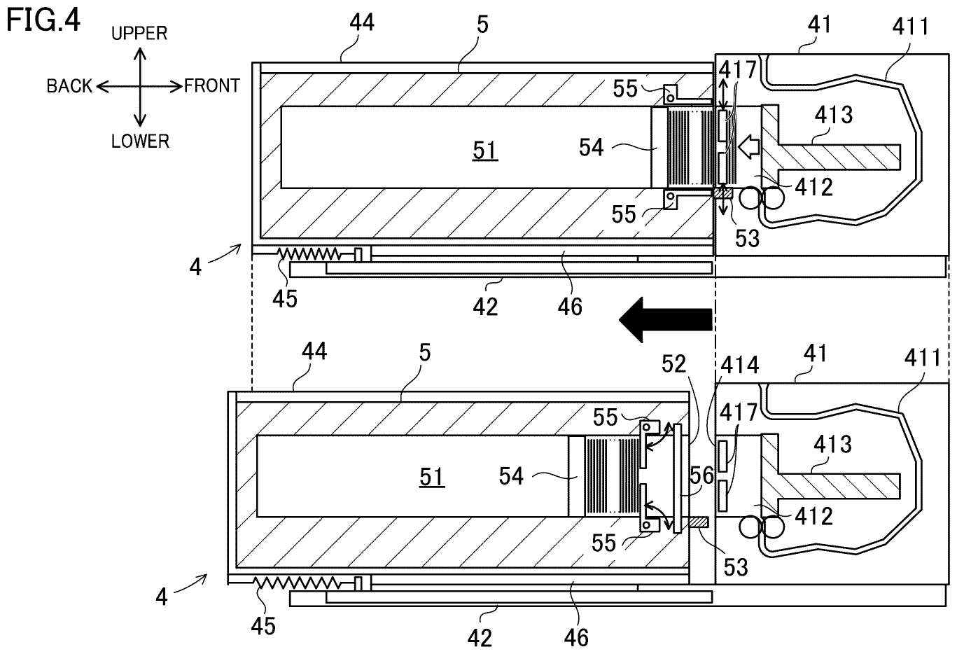

FIG. 4 schematically illustrates a structure of the collection unit 4. The left and right sides of FIG. 4 are oriented to be opposite to the left and right sides, respectively, of FIG. 2.

The base 42 extends in the front-rear direction. In other words, the base 42 extends in the pulling/pushing direction in which the collection unit 4 is pulled out of, or pushed into, the money handling device 1. The third transport unit 41 is located on a first side (i.e., the front side) of the base 42, and the collection cassette 5 is located on a second side (i.e., the back side) of the base 42. The third transport unit 41 and the collection cassette 5 are adjacent to each other in the pulling/pushing direction. The direction in which the third transport unit 41 and the collection cassette 5 are arranged is not limited to a specific direction.

The third transport unit 41 has a transport path 411. A first end of the transport path 411 is open in the upper surface of the third transport unit 41. The first end of the transport path 411 is connected to the transport path of the second transport unit 39. A second end of the transport path 411 is connected to a stacking space 412. The transport path 411 is disposed between the first end and the second end to bypass a pusher 413, which will be described later.

The stacking space 412 has an opening 414. The opening 414 is a second opening 414 connected to a first opening 52 of the collection cassette 5, which will be described later. The second opening 414 faces the collection cassette 5. That is to say, the second opening 414 of the stacking space 412 faces backward on the back surface of the third transport unit 41.

The stacking space 412 extends in a first direction. The first direction is a direction in which the banknotes are sent from the third transport unit 41 to the collection cassette 5. In this money handling device 1, the first direction corresponds to the front-rear direction, and corresponds to the pulling/pushing direction. The second end of the transport path 411 is connected to the lower surface of the stacking space 412. The banknotes transported to the stacking space 412 along the transport path 411 are arranged in the first direction and stacked in the stacking space 412 while being oriented to stand with a long edge of each banknote oriented downward, as illustrated in an upper part of FIG. 4.

The third transport unit 41 includes the pusher 413. The pusher 413 is located on the front side (i.e., the first side in the first direction) of the stacking space 412. The pusher 413 reciprocates along the first direction.

The third transport unit 41 includes stoppers 417. The stoppers 417 are located on the back side (i.e., the second side in the first direction) of the stacking space 412. The stoppers 417 are movable between their position in which the second opening 414 is closed and their position in which the second opening 414 is opened (see an arrow in the upper part of FIG. 4). While the stoppers 417 close the second opening 414, the banknotes stacked in the stacking space 412 are held between the stoppers 417 and the pusher 413.

The collection cassette 5 has a rectangular box shape. In the example in FIG. 4, the collection cassette 5 is mounted to the base 42 while being oriented to extend in the first direction.

The collection cassette 5 has a storage space 51. The storage space 51 stores banknotes. The storage space 51 extends in the first direction. A stage 54 is located in the storage space 51. The stage 54 moves through the storage space 51 in the first direction in accordance with the amount of the banknotes stored.

The storage space 51 has the first opening 52. The first opening 52 is connected to the second opening 414 of the third transport unit 41. The first opening 52 faces the third transport unit 41. That is to say, the first opening 52 faces forward on the front surface of the collection cassette 5.

The first opening 52 is provided with a guide 53. The guide 53 is interposed between the first opening 52 and the second opening 414 connected to each other, thereby guiding the banknotes to be sent from the second opening 414 to the first opening 52.

When the banknotes are to be sent from the third transport unit 41 to the collection cassette 5, the stoppers 417 move to the position in which the second opening 414 is opened, and the pusher 413 pushes the banknotes in the stacking space 412 toward the collection cassette 5 (see the hollow arrow in the upper part of FIG. 4). The banknotes pass through the second opening 414 and the first opening 52 in the first direction so as to be sent into the storage space 51 of the collection cassette 5. In the storage space 51, the banknotes are arranged in the first direction while being oriented to stand with a long edge of each banknote oriented downward.

The collection cassette 5 includes stoppers 55. The stoppers 55 have the function of pressing the banknotes stored in the storage space 51 between the stopper 55 and the stage 54. The stoppers 55 change their orientations between a pressing position (see a lower part of FIG. 4) in which the stoppers 55 are located inside the storage space 51 to press the banknotes and a retracted position (see the upper part of FIG. 4) in which the stoppers 55 are located outside the storage space 51. When the collection cassette 5 is to be attached to, and detached from, the base 42, the stoppers 55 are positioned in the pressing position, and in a state where the collection cassette 5 is mounted to the base 42, the stoppers 55 are positioned in the retracted position.

As illustrated in the lower part of FIG. 4, the collection cassette 5 includes a shutter 56. The shutter 56 opens and closes the first opening 52. Basically, when the collection cassette 5 is to be attached to and detached from the base 42, the shutter 56 closes the first opening 52, and in a state where the collection cassette 5 is mounted to the base 42, the shutter 56 opens the first opening 52. When the collection cassette 5 is to be attached to and detached from the base 42, the shutter 56 restricts the exit of the banknotes stored in the storage space 51 from the first opening 52.

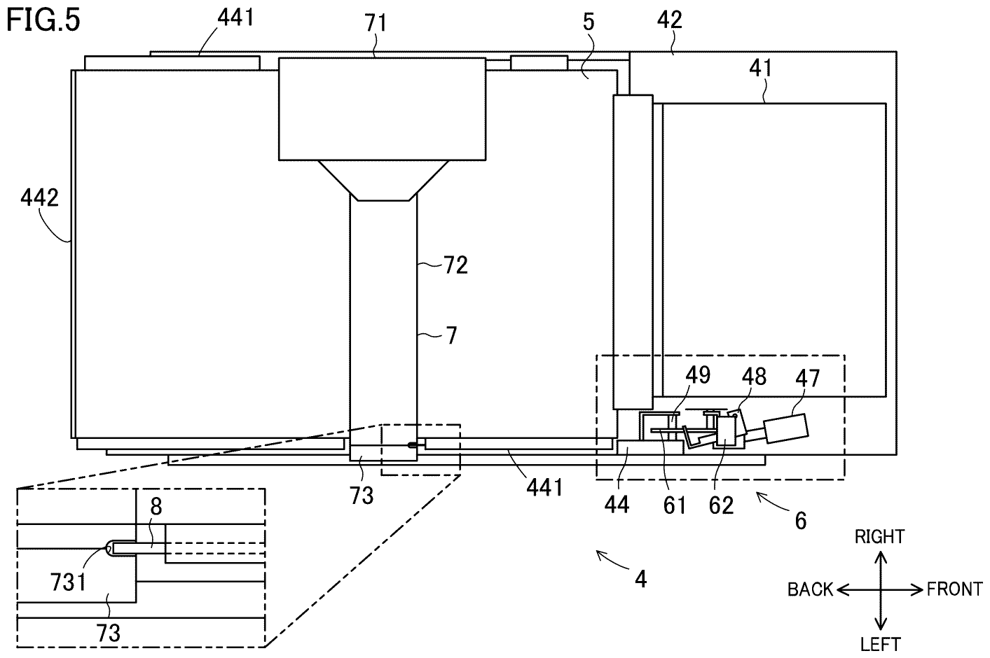

The base 42 includes a frame 44 (see also FIG. 5, 8, 9, or 10). The frame 44 holds the collection cassette 5. The frame 44 holds the collection cassette 5 so that the collection cassette 5 is detachable in a second direction orthogonal to the first direction. The second direction corresponds to the up-down direction.

The frame 44 has a pair of side walls 441, 441 and one back wall 442 in the illustrated example. The pair of side walls 441, 441 support the corresponding side surfaces of the collection cassette 5 on the right and left sides of the collection cassette 5. The back wall 442 supports the back surface of the collection cassette 5 on the back side of the collection cassette 5. The back surface of the collection cassette 5 is a surface of the collection cassette 5 opposite to the surface thereof having the first opening 52.

The frame 44 is attached to the base 42 via a slider 46. The slider 46 extends in the first direction. The frame 44 is moved relative to the base 42 in the first direction by the slider 46. The relative movement of the frame 44 causes the collection cassette 5 held by the frame 44 to move in the first direction between a first position in which the collection cassette 5 engages with the third transport unit 41 as illustrated in the upper part of FIG. 4 and a second position in which the collection cassette 5 is disengaged from the third transport unit 41 as illustrated in the lower part of FIG. 4. In the first position, the first opening 52 of the collection cassette 5 and the second opening 414 of the third transport unit 41 are connected to each other. In the second position, the first opening 52 and the second opening 414 are disconnected from each other.

A first biasing member 45 is interposed between the base 42 and the frame 44. The first biasing member 45 is, for example, a compression or extension coil spring. In a state where the collection cassette 5 and the third transport unit 41 are connected to each other, the first biasing member 45 biases the frame 44 in a direction in which the frame 44 moves away from the third transport unit 41. As will be described later, disconnecting the collection cassette 5 and the third transport unit 41 from each other allows the frame 44 and the collection cassette 5 to move in a direction away from the third transport unit 41 under the biasing force of the first biasing member 45 (see the black arrow in FIG. 4). The frame 44 and the collection cassette 5 moving backward allow the guide 53 to be disengaged from the third transport unit 41 as illustrated in the lower part of FIG. 4.

(Structure Guaranteeing that Collection Cassette is Detached Through Appropriate Procedure)

As described above, the collection cassette 5 is attached to and detached from the base 42 in the second direction, i.e., the up-down direction, orthogonal to the first direction, which is the direction of feeding of the banknotes. During operation of the money handling device 1, the first opening 52 of the collection cassette 5 and the second opening 414 of the third transport unit 41 are connected to each other, and the guide 53 is engaged between the first opening 52 and the second opening 414. If, when the collection cassette 5 is to be detached from the base 42, the operator attempts to lift the collection cassette 5 with the first opening 52 and the second opening 414 connected to each other and with the guide 53 engaged with the third transport unit 41, the guide 53 may interfere with the third transport unit 41 to damage the collection cassette 5 and/or the third transport unit 41.

To address this problem, the collection unit 4, which serves as the money storage device, has a specific structure. This specific structure guarantees that the collection cassette 5 is attached and detached through an appropriate procedure, and reduces damage to the collection cassette 5 and/or the third transport unit 41. The specific structure will be described in detail below with reference to the drawings.

FIG. 5 is a plan view of the collection unit 4. The collection unit 4 includes the switch 6. The switch 6 switches between connection and disconnection between the first opening 52 and the second opening 414. As described above, the connection and disconnection between the first opening 52 and the second opening 414 depend on the movement of the collection cassette 5 in the first direction. The slider 46 (see FIG. 4 and any other figure) that enables the movement of the collection cassette 5 and the frame 44 relative to the base 42 forms part of the switch 6.

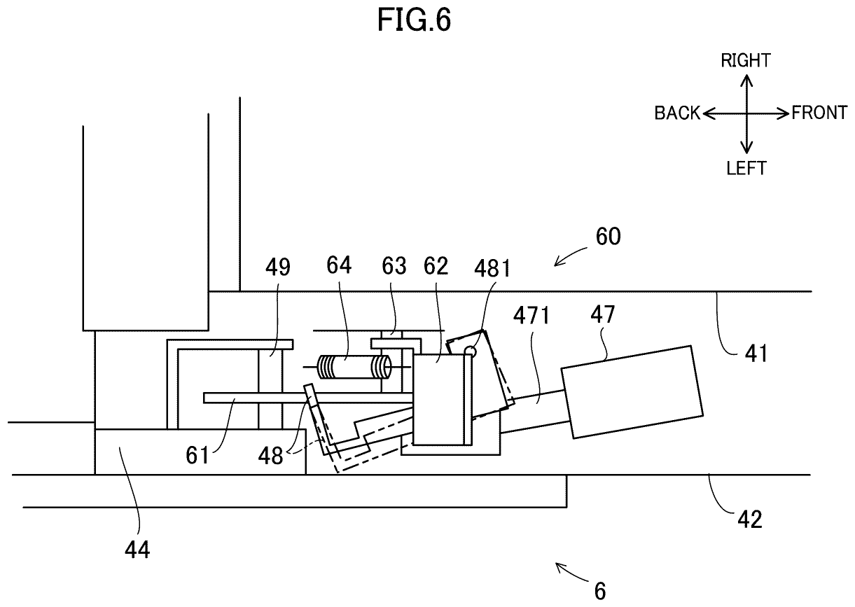

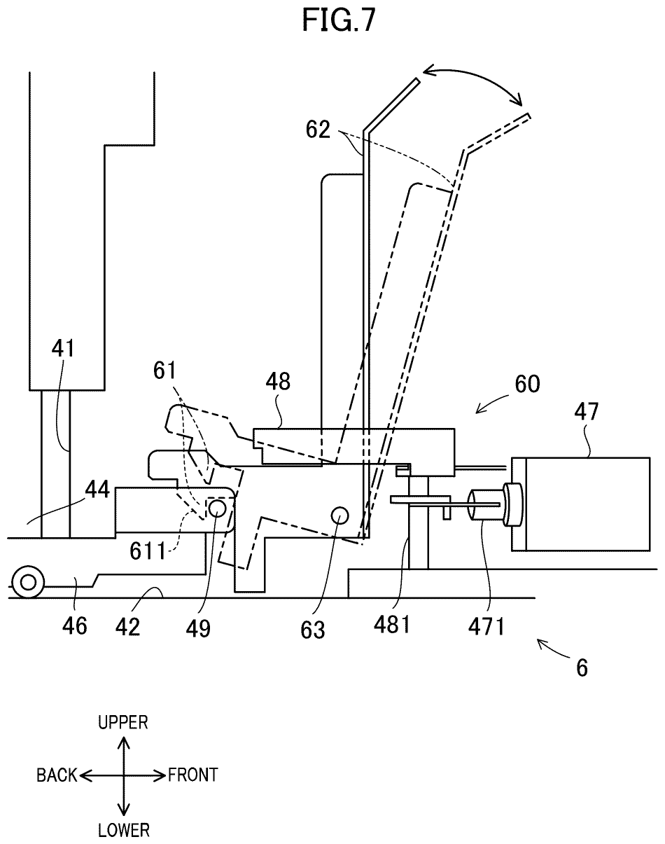

FIG. 6 is an enlarged plan view of an area surrounded by the dash-dot quadrangle in FIG. 5. FIG. 6 is a plan view of the switch 6. FIG. 7 is a side view of the switch 6.

The switch 6 includes a hook 61. The hook 61 is located in a lateral direction of the third transport unit 41. The hook 61 is attached to the base 42. The hook 61 engages with a pin 49 attached to the frame 44. The pin 49 is located at a front end portion of the frame 44. The hook 61 engaging with the pin 49 brings the collection cassette 5 closer to the third transport unit 41, thus connecting the first opening 52 and the second opening 414 together. As described above, the frame 44 is biased backward relative to the base 42 by the first biasing member 45. Thus, the hook 61 holds the frame 44 and the collection cassette 5 held in the frame 44 in the first position close to the third transport unit 41 against the biasing force of the first biasing member 45. The hook 61 is an exemplary engaging member.

The switch 6 includes a lever 62. The lever 62 is manually handled by the operator. A lower end of the lever 62 is supported by a first shaft 63 extending in the lateral direction. The lever 62 switches between a position in which the lever 62 stands upright as indicated by the solid lines in FIG. 7 and a position in which the lever 62 tilts forward as indicated by the dash-dot-dot lines in FIG. 7. The hook 61 is integrated with the lever 62 at the lower end of the lever 62. If the lever 62 is in the position in which it stands upright, the hook 61 engages with the pin 49. If the lever 62 is in the position in which it is tilted, the hook 61 moves upward so as to be disengaged from the pin 49.

As illustrated in FIG. 6, a second biasing member 64 is connected to the lever 62. The second biasing member 64 is, for example, an extension coil spring. If the lever 62 is in the position in which it is tilted, the second biasing member 64 biases the lever 62 such that the lever 62 stands upright. The second biasing member 64 maintains the hook 61 engaged with the pin 49. The switch 6 can maintain the collection cassette 5 and the third transport unit 41 engaged with each other.

If the collection cassette 5 and the third transport unit 41 are to be disengaged from each other, the operator tilts the lever 62 forward against the biasing force of the second biasing member 64. The hook 61 is disengaged from the pin 49. The first biasing member 45 moves the frame 44 backward. As a result, the collection cassette 5 moves away from the third transport unit 41 to disconnect the first opening 52 and the second opening 414 from each other (see FIG. 4).

The switch 6 includes the second electromagnetic lock 47. The second electromagnetic lock 47 is a lock mechanism that restricts handling of the lever 62. The second electromagnetic lock 47 in the illustrated example is a solenoid actuator including a rod 471 that advances and retracts. The second electromagnetic lock 47 is not limited to the solenoid actuator including the rod 471. The second electromagnetic lock 47 is fixed to the base 42 so as to be oriented such that the rod 471 advances and retracts in substantially the front-rear direction.

The leading edge of the rod 471 is connected to a bell crank 48. The bell crank 48 is supported by a second shaft 481 extending in the up-down direction. The advance and retraction of the rod 471 allows the bell crank 48 to turn around the second shaft 481.

The leading edge of the bell crank 48 is located in the position in which it interferes with the lever 62 above the lever 62 standing upright (see the solid lines in FIG. 6). If the lever 62 and the bell crank 48 interfere with each other, the operator cannot tilt the lever 62. The handling of the lever 62 is restricted.

When the advance and retraction of the rod 471 of the second electromagnetic lock 47 causes the bell crank 48 to turn, the leading edge of the bell crank 48 moves from above the lever 62 to eliminate the interference between the bell crank 48 and the lever 62 as indicated by the dash-dot-dot lines in FIG. 6. In this state, the operator can tilt the lever 62.

The second electromagnetic lock 47 restricts the handling of the lever 62 when not energized. Upon receipt of the release signal from the collection unit CPU 40, the second electromagnetic lock 47 releases the restriction of the handling of the lever 62.

The hook 61, the lever 62, and the second electromagnetic lock 47 form a second restrictor 60. The second restrictor 60 restricts the movement of the collection cassette 5 to prevent the collection cassette 5 and the third transport unit 41 connected to each other from being separated from each other in the first direction.

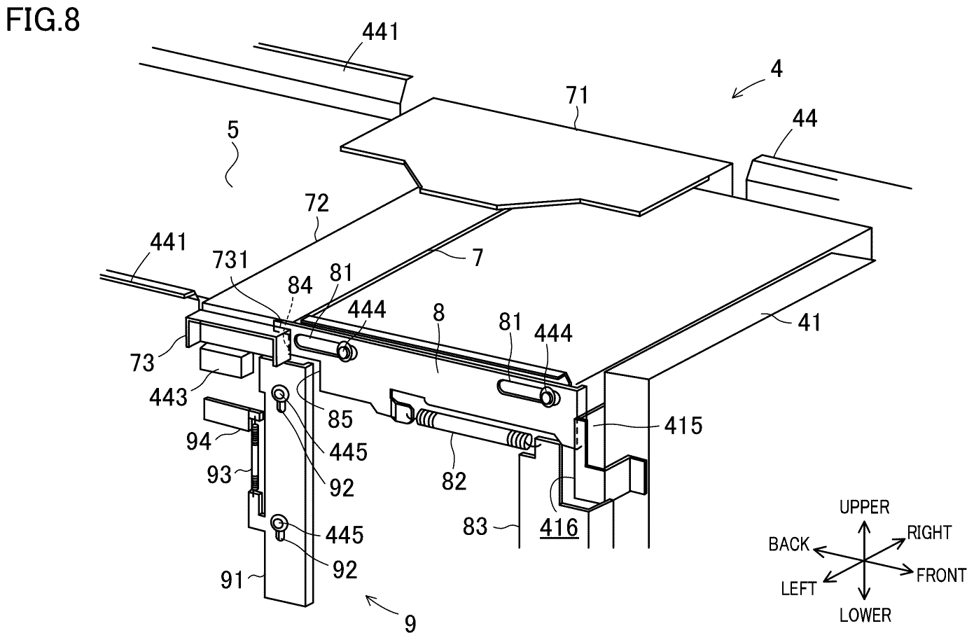

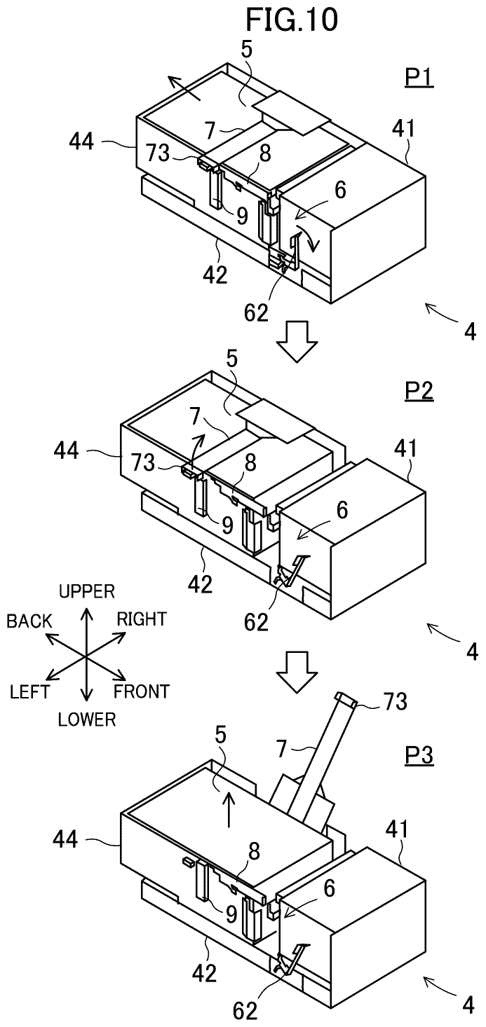

The collection unit 4 includes a first restrictor 7. The first restrictor 7 is a cover that is closed to cover at least one portion of the collection cassette 5 to thereby restrict the detachment of the collection cassette 5 as illustrated in FIG. 5, 8, or 10 and that is opened to uncover the collection cassette 5 to thereby allow the detachment of the collection cassette 5 as illustrated in FIG. 10. As illustrated in FIG. 5 or 8, the first restrictor 7 includes a root end portion 71, an intermediate portion 72, and a leading edge portion 73.

The root end portion 71 is attached to the right side wall 441 of the frame 44. The root end portion 71 is supported by a shaft extending in the front-rear direction. As illustrated in FIG. 10, the first restrictor 7 is turnable between a position in which the first restrictor 7 covers a portion of the upper surface of the collection cassette 5 and a position in which the first restrictor 7 uncovers the upper surface of the collection cassette 5.

The intermediate portion 72 couples the root end portion 71 and the leading edge portion 73 together in the lateral direction. When the first restrictor 7 is in the closed state, the intermediate portion 72 is located on the upper side of the collection cassette 5. The intermediate portion 72 and the collection cassette 5 are adjacent to each other in the second direction. The intermediate portion 72 and the collection cassette 5 interfering with each other allows the first restrictor 7 to restrict the detachment of the collection cassette 5.

As illustrated in FIG. 8, when the first restrictor 7 is in the closed state, the leading edge portion 73 is located near the left side wall 441 of the frame 44. A magnet 443 is attached to the left side wall 441. The leading edge portion 73 is attracted to the magnet 443. The first restrictor 7 maintains its closed state.

The leading edge portion 73 has a locking portion 731 (see the enlarged view in FIG. 5). The locking portion 731 is a groove that opens on the front side of the leading edge portion 73, i.e., toward the third transport unit 41. The leading edge of a link member 8, which will be described later, is locked in the locking portion 731. In the locked state where the link member 8 is locked in the locking portion 731, the leading edge portion 73 cannot move upward. That is to say, the first restrictor 7 cannot shift from the closed state to the open state. As will be described later, in a non-locked state where the link member 8 is not locked in the locking portion 731, the leading edge portion 73 can move upward, and the first restrictor 7 can shift from the closed state to the open state. The shape of the groove serving as the locking portion 731 is an example, and is not limited to that in this embodiment. The locking portion 731 may have a shaft shape protruding from the leading edge portion 73 below the leading edge of the link member 8, and may be configured such that the leading edge of the link member 8 engaged with the shaft restricts the upward movement of the leading edge portion 73. The locking portion 731 may have a shaft shape protruding from the leading edge portion 73 toward the intermediate portion 72.

The link member 8 is attached to the frame 44. The link member 8 is located on the lateral side of the left side wall 441 and on the front side of the first restrictor 7. The link member 8 is a plate-shaped member extending in the front-rear direction, i.e., in the first direction. The link member 8 is arranged between the first restrictor 7 and the third transport unit 41 to bridge the first restrictor 7 and the third transport unit 41. Two portions of the link member 8 on the front and back sides thereof each have a long hole 81. The long holes 81 extend in the front-rear direction. A support pin 444 fixed to each side wall 441 is inserted into the corresponding long hole 81. The link member 8 is supported by the corresponding side wall 441. The link member 8 is also movable relative to the frame 44 in the front-rear direction.

A first end of a third biasing member 82 is attached to the link member 8. A second end of the third biasing member 82 is attached to a support member 83. The support member 83 is fixed to a front end portion of the side wall 441 of the frame 44. The third biasing member 82 may be, for example, an extension coil spring extending in the front-rear direction. When extended, the third biasing member 82 biases the link member 8 forward, i.e., in a direction away from the first restrictor 7.

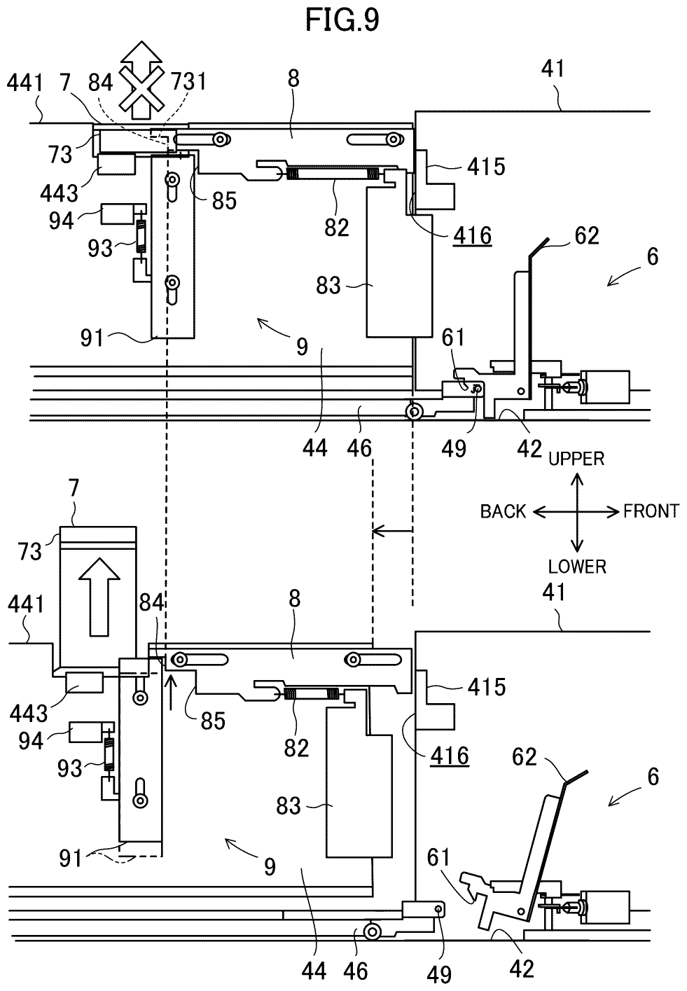

A contact member 415 is attached to a back end portion of the third transport unit 41. The contact member 415 has a contact surface 416 that faces backward (see also FIG. 9). The root end of the link member 8, i.e., the front end of the link member 8 extending in the front-rear direction, is in contact with the contact surface 416. More specifically, in a state where the frame 44 is moved forward to connect the collection cassette 5 and the third transport unit 41 together, the root end of the link member 8 is in contact with the contact surface 416. In this state, the leading edge of the link member 8, i.e., the back end of the link member 8, is locked in the locking portion 731 of the first restrictor 7 described above. In a state where the collection cassette 5 and the third transport unit 41 are connected to each other, the distance from the locking portion 731 to the contact surface 416 corresponds to the length of the link member 8 in the front-rear direction. In the locked state where the leading edge of the link member 8 is locked in the locking portion 731, the third biasing member 82 is extended in the front-rear direction, and a forward biasing force of the third biasing member 82 acts on the link member 8.

As illustrated in an upper part of FIG. 9, in a state where the collection cassette 5 is engaged with the third transport unit 41, the leading edge of the link member 8 is locked in the locking portion 731 of the first restrictor 7. Even if the operator attempts to lift the leading edge portion 73 of the first restrictor 7, interference between the link member 8 and the leading edge portion 73 prevents the operator from lifting the leading edge portion 73. Since the first restrictor 7 is in a closed position, the operator cannot even detach the collection cassette 5 upward from the frame 44. Furthermore, a handle for lifting the collection cassette 5 may be provided on the upper side of the collection cassette 5, and the first restrictor 7 in the closed position may cover the handle.

If the collection cassette 5 engaged with the third transport unit 41 is to be detached, the operator tilts the lever 62 of the switch 6 to disengage the hook 61 and the pin 49 from each other as described above (see a lower part of FIG. 9). Assume here that the second electromagnetic lock 47 is unlocked.

Disengaging the hook 61 and the pin 49 from each other allows the first biasing member 45 between the base 42 and the frame 44 to move the frame 44 backward relative to the base 42. The frame 44 moving backward increases the spacing between the leading edge portion 73 of the first restrictor 7 attached to the frame 44 and the contact member 415 fixed to the third transport unit 41. The link member 8 is biased forward by the third biasing member 82 as described above, and thus moves forward relative to the frame 44 moving backward. As a result, the leading edge of the link member 8 is disengaged from the locking portion 731 of the leading edge portion 73. This prevents the link member 8 and the first restrictor 7 from interfering with each other, thus allowing the operator to lift the leading edge portion 73. The first restrictor 7 turned to its open position allows the operator to detach the collection cassette 5 upward from the frame 44.

A third restrictor 9 is also attached to the left side wall 441 of the frame 44. The third restrictor 9 restricts the attachment of the collection cassette 5 so that this attachment is performed through a predetermined procedure. Specifically, in a state where the first restrictor 7 restricts the detachment of the collection cassette 5, in other words, in a case where the first restrictor 7 is in the closed position, the third restrictor 9 moves the frame 44 forward to enable engagement between the collection cassette 5 and the third transport unit 41. Meanwhile, in a state where the first restrictor 7 does not restrict the detachment of the collection cassette 5, in other words, in a case where the first restrictor 7 is not in the closed position, the third restrictor 9 restricts the forward movement of the frame 44.

As illustrated in FIG. 8, the third restrictor 9 includes a stopper 91. The stopper 91 is located near the leading edge of the link member 8. The stopper 91 extends in the up-down direction. The stopper 91 has two long holes 92 in an upper portion and a lower portion thereof. The long holes 92 extend in the up-down direction. Support pins 445 fixed to the side wall 441 are inserted into the respective long holes 92, and the stopper 91 is supported by the side wall 441. The stopper 91 is also movable relative to the frame 44 in the up-down direction.

A first end of a fourth biasing member 93 is attached to the stopper 91. A second end of the fourth biasing member 93 is attached to an attachment member 94. The attachment member 94 is fixed to the corresponding side wall 441. The fourth biasing member 93 may be, for example, an extension coil spring extending in the up-down direction. If the fourth biasing member 93 is contracted, the fourth biasing member 93 biases the stopper 91 upward.

If the leading edge portion 73 of the first restrictor 7 is attracted to the magnet 443, the upper end of the stopper 91 comes into contact with the leading edge portion 73 so as to be pressed downward (see the upper part of FIG. 9). In this state, the stopper 91 does not interfere with the link member 8, and the frame 44 can thus move forward toward the third transport unit 41. An upper end portion of the stopper 91 is located at a position corresponding to a cutout 85 formed in the leading edge portion of the link member 8. As a result of the forward movement of the frame 44, the collection cassette 5 and the third transport unit 41 can be connected to each other, and the leading edge of the link member 8 can be locked in the locking portion 731 of the leading edge portion 73.

On the other hand, if the leading edge portion 73 of the first restrictor 7 is not attracted to the magnet 443, the stopper 91 moves upward under the biasing force of the fourth biasing member 93 as indicated by the solid lines in the lower part of FIG. 9. If the first restrictor 7 is not in the closed position, the frame 44 is apart from the third transport unit 41. The upper end portion of the stopper 91 that has moved upward engages with a step 84 formed on a front end portion of the link member 8. The step 84 is located above the cutout 85 and behind the cutout 85.

Even if, in this state, an attempt is made to move the frame 44 toward the third transport unit 41, the interference between the stopper 91 and the link member 8 prevents the frame 44 from being moved.

On the other hand, if the first restrictor 7 is in the closed position, and the leading edge portion 73 is attracted to the magnet 443, the stopper 91 is pushed by the leading edge portion 73 to move downward (see the dash-dot-dot lines in the lower part of FIG. 9). The downward movement of the stopper 91 prevents the stopper 91 from interfering with the step 84. Thus, the frame 44 can be moved forward, and the collection cassette 5 thus engages with the third transport unit 41.

The third restrictor 9 can restrict the mounting of the collection cassette 5 so that the collection cassette 5 is mounted through a predetermined procedure.

Next, the procedure through which the collection cassette 5 is detached from the collection unit 4 pulled out of the lower housing 12 of the money handling device 1 will be described with reference to the transition diagram in FIG. 10. Assume that the second electromagnetic lock 47 is unlocked. First, the operator tilts the lever 62 forward in Step P1 (see the corresponding arrow in an upper part of FIG. 10). This causes the hook 61 and the pin 49 to be disengaged from each other. Thus, the frame 44 moves backward under the biasing force of the first biasing member 45. The operator simply performing the operation of tilting the lever 62 allows the first opening 52 of the collection cassette 5 and the second opening 414 of the third transport unit 41 to be disconnected from each other.

The backward movement of the frame 44 causes the leading edge of the link member 8 to be disengaged from the locking portion 731 of the leading edge portion 73 of the first restrictor 7. The operator may move the frame 44 further backward to a predetermined position as necessary. The leading edge of the link member 8 is reliably disengaged from the locking portion 731 of the leading edge portion 73 of the first restrictor 7.

When the link member 8 is unlocked, the operator lifts the leading edge portion 73 of the first restrictor 7 in Step P2 to shift the first restrictor 7 to its open state (see the arrow in an intermediate part of FIG. 10). Since the restriction of the first restrictor 7 is released, the operator can detach the collection cassette 5 upward in Step P3 (see the arrow in a lower part of FIG. 10).

As can be seen, moving the collection cassette 5 backward to disengage the collection cassette 5 and the third transport unit 41 from each other can trigger the change of the first restrictor 7 from the closed state to the open state, thereby detaching the collection cassette 5 from the frame 44. The operator detaches the collection cassette 5 through the predetermined procedure. Thus, a breakage of the collection cassette 5 and/or the third transport unit 41 is prevented before it occurs.

The procedure through which the collection cassette 5 is attached to the collection unit 4 is the reverse of the above-described procedure. That is to say, when the first restrictor 7 is in the open state, the operator lowers the collection cassette 5 into the frame 44. Thereafter, the operator brings the first restrictor 7 into the closed state. Attraction of the leading edge portion 73 to the magnet 443 allows the stopper 91 to be pressed downward. In this state, the operator can move the frame 44 forward. The operator moves the frame 44 forward against the biasing force of the first biasing member 45. As described above, if the first restrictor 7 is in the open state, interference between the stopper 91 and the link member 8 prevents the frame 44 from moving forward.

The operator moves the frame 44 forward to engage the pin 49 with the hook 61. As illustrated in FIG. 7, the hook 61 has an inclined portion 611. Thus, when the pin 49 with a circular transverse section moves forward, the pin 49 comes into contact with the inclined portion 611. As a result, the lever 62 pushed by the pin 49 to stand upright tilts forward. After the pin 49 has passed through the inclined portion 611, the lever 62 is automatically returned to its standing state by the second biasing member 64. The hook 61 engages with the pin 49. That is to say, the hook 61 can be engaged with the pin 49 simply by the operator moving the frame 44 forward. If the frame 44 is moved forward to its position in which the hook 61 and the pin 49 are engaged with each other, the first opening 52 of the collection cassette 5 and the second opening 414 of the third transport unit 41 are connected to each other.

The operator mounts the collection cassette 5 through the predetermined procedure. Thus, a breakage of the collection cassette 5 and/or the third transport unit 41 is prevented before it occurs. Furthermore, the third restrictor 9 guarantees that the collection cassette 5 is correctly attached to the base 42. Thus, in a state where the collection cassette 5 and the third transport unit 41 are connected to each other, the operator cannot detach the collection cassette only through the predetermined procedure as described above.

In the above-described collection unit 4 (that is to say, the money storage device), the movement of the collection cassette 5 causes the collection cassette 5 to be disconnected from the third transport unit 41. Alternatively, the movement of the third transport unit 41 instead of the collection cassette 5 may cause the collection cassette 5 and the third transport unit 41 to be disconnected from each other. After the collection cassette 5 and the third transport unit 41 have been disconnected from each other, the collection cassette 5 is detached from the base 42.

The movement of each of the collection cassette 5 and the third transport unit 41 may allow the collection cassette 5 and the third transport unit 41 to be disconnected from each other.

In addition, the collection cassette 5 (or the third transport unit 41) does not always move horizontally so as to be disconnected. The collection cassette 5 (or the third transport unit 41) may move vertically so as to be disconnected.

Connection between the collection cassette 5 and the third transport unit 41 is not limited to mechanical connection between the first opening 52 and the second opening 414, and may be, for example, electrical connection via a terminal therebetween. In this case, the first restrictor 7 may release the restriction of the detachment of the collection cassette 5 in response to electrical disconnection between the collection cassette 5 and the third transport unit 41. The terminal may be a terminal related to the transfer of a signal between the money handling device 1 and the collection cassette 5 and/or a terminal related to the supply of power from the money handling device 1 to the collection cassette 5.

The switch 6 includes the lever 62 that is manually handled by the operator, but the manual lever 62 may be omitted. In this case, an actuator forming the second electromagnetic lock 47 may directly switch between engagement and disengagement of the hook 61.

The collection cassette 5 is not always held by the frame 44, and may be directly supported by the base 42 so as to be relatively movable. In this case, the hook 61 may engage with the collection cassette 5.

### (Control Related to Detachment of Collection Cassette)

In the collection process, the collection cassette 5 is detached from the money handling device 1 after the banknotes to be collected have been stored in the collection cassette 5. The collection cassette 5 of the money handling device 1 has the first opening 52 in its front surface. When the collection cassette 5 is detached with the lateral first opening 52 left open, the banknotes stored in the collection cassette 5 may exit through the first opening 52. Thus, in the collection process, the collection cassette 5 closes the above-described shutter 56 upon receipt of a control signal from the collection unit CPU 40 before the detachment of the collection cassette 5.

The collection cassette 5 may be detached in a process other than the collection process. For example, if a transport error occurs, the collection cassette 5 may be detached from the collection unit 4 to recover from the transport error. In this case, depending on the location of the occurrence of the transport error, the collection cassette 5 needs to be detached from the collection unit 4 with the first opening 52 of the collection cassette 5 left open. There is a need to detach the collection cassette 5 through the predetermined procedure also for the purpose of reducing the exit of the banknotes stored in the collection cassette 5 from the first opening 52.

The money handling device 1 switches control related to the detachment of the collection cassette 5 between a first mode and a second mode in accordance with a factor in detaching the collection cassette 5.

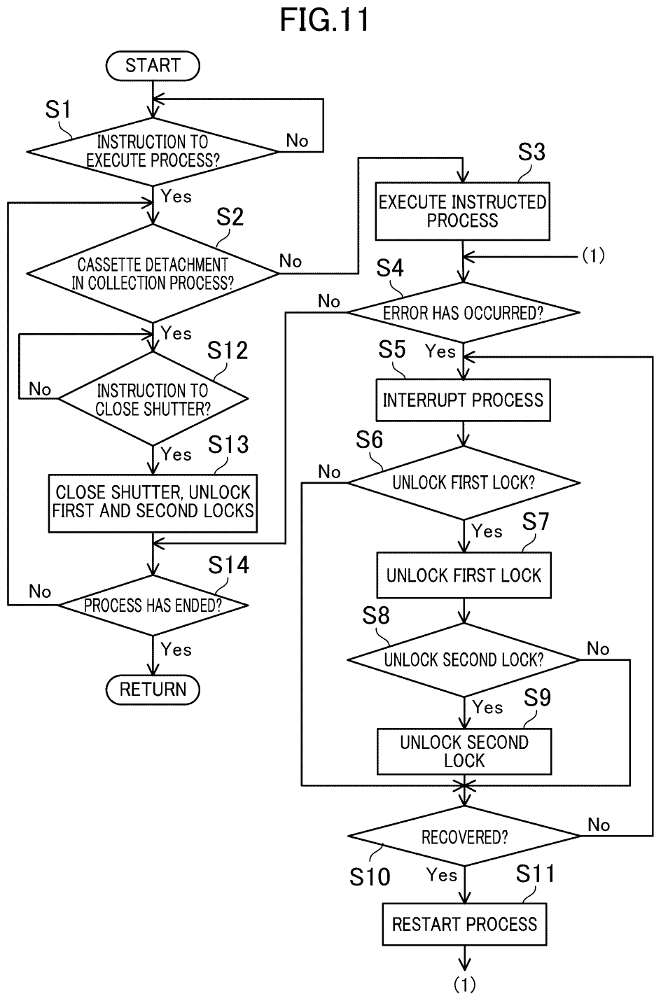

FIG. 11 shows a control procedure performed by the money handling device 1 and related to the detachment of the collection cassette 5. The control procedure in FIG. 11 is implemented through control of the components of the money handling device 1 by the upper CPU 20, the lower CPU 30, and/or the collection unit CPU 40. In Step S1 after the start, the money handling device 1 determines whether or not the user has issued an instruction to execute a process. As described above, the user issues an instruction to execute various processes through the interface unit 21. If the determination in Step S1 is “No,” the money handling device 1 waits. If the determination in Step S1 is “Yes,” the money handling device 1 determines, in Step S2, whether or not the process is detachment of the collection cassette 5 in the collection process. Here, the description will be continued on the assumption that the determination in Step S2 is “No.”

In Step S3, the money handling device 1 executes the process that the user issues the instruction to execute, for example, the depositing process, the dispensing process, or the collection process. Suppose here that the instruction has been issued to execute the collection process. In the collection process, the money handling device 1 transfers banknotes to be collected from one or more of the storage cassettes 31 to 38 storing the banknotes to the collection cassette 5.

In Step S4, the money handling device 1 determines whether or not an error has occurred during the execution of the process. The error is, for example, a banknote jam. If no error has occurred, the money handling device 1 determines, in Step S14, whether or not the process has been completed. If the process has not been completed, the control process returns to Step S4 via Steps S2 and S3. Meanwhile, the money handling device 1 continues the process.

If an error has occurred during the process, the determination in Step S4 is “Yes.” The money handling device 1 interrupts the process in subsequent Step S5. The money handling device 1 needs to recover from the error. Suppose here that an error has occurred in the collection unit 4.

There are three patterns of recovery of the money handling device 1 from an error: (1) recovery can be performed without pulling the collection unit 4 out of the lower housing 12, (2) recovery can be performed by pulling the collection unit 4 out of the lower housing 12 without detaching the collection cassette 5, and (3) recovery can be performed by pulling the collection unit 4 out of the lower housing 12 and detaching the collection cassette 5. A person in charge of the error recovery performs recovery work in accordance with the pattern (1), (2), or (3). If the pattern (2) or (3) in which the collection unit 4 is pulled out of the lower housing 12 is implemented, the person in charge requires special authority.

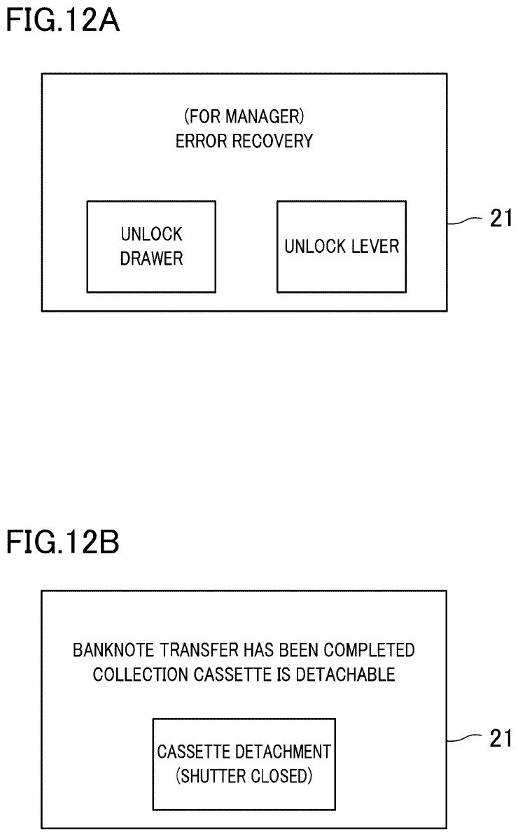

If the collection unit 4 needs to be pulled out of the lower housing 12, the person in charge of the error recovery issues an instruction through the interface unit 21 to unlock the first electromagnetic lock 43. If the person in charge is a person who has special authority, the interface unit 21 displays a screen through which an instruction can be issued to unlock the first electromagnetic lock 43 (that is to say, “to unlock a drawer”) as shown in FIG. 12A, for example. If the person in charge is different from the person who has special authority, the interface unit 21 does not display the screen through which the instruction can be issued to unlock the first electromagnetic lock 43. The interface unit 21 outputs an operation signal corresponding to the operator's operation to the upper CPU 20. A release instruction signal for the first electromagnetic lock 43 is an exemplary operation signal.

In Step S6, the money handling device 1 determines whether or not an instruction has been issued to unlock the first electromagnetic lock 43. If the determination in Step S6 is “YES,” the money handling device 1 unlocks the first electromagnetic lock 43 in Step S7. The person in charge can unlock the door 121 and pull the collection unit 4 out of the lower housing 12.

In Step S8, the money handling device 1 determines whether or not an instruction has been issued to unlock the second electromagnetic lock 47. The determination in Step S8 is based on the presence or absence of a release instruction signal for the second electromagnetic lock 47 from the interface unit 21. If the person in charge is a person who has special authority, the interface unit 21 displays a screen through which an instruction has been issued to unlock the second electromagnetic lock 47 (that is to say, “to unlock the lever”) as shown in FIG. 12A, for example. If the person in charge is different from the person who has special authority, the interface unit 21 does not display the screen through which the instruction has been issued to unlock the second electromagnetic lock 47.

If the determination in Step S8 is “YES,” the money handling device 1 unlocks the second electromagnetic lock 47 in Step S9. The person in charge can handle the lever 62 of the switch 6. The procedure through which the collection cassette 5 is detached and which includes handling of the lever 62 of the switch 6 is as described above. In this case, the first opening 52 of the collection cassette 5 is left open. This allows the banknotes stored in the collection cassette 5 to be taken out through the first opening 52 for the time being. Meanwhile, since the person in charge of the recovery work has special authority, security is maintained. If the determination in Step S8 is “No,” the control process skips Step S9 and proceeds to Step S10. Note that if the determination in Step S6 is “No,” the control process proceeds to Step S10. This is because the collection cassette 5 is not detached unless the collection unit 4 is pulled out of the lower housing 12.

In the recovery from the error, the money handling device 1 individually receives the release instruction signal for the first electromagnetic lock 43 and the release instruction signal for the second electromagnetic lock 47. The first electromagnetic lock 43 and/or the second electromagnetic lock 47 are/is unlocked based on the release instruction signal for the first electromagnetic lock 43 and/or the release instruction signal for the second electromagnetic lock 47. Thus, the person in charge can unlock only the lock mechanism(s) that needs to be unlocked, and can smoothly recover the money handling device 1 without misoperation.

In Step S10, the money handling device 1 determines whether or not it has recovered from the error. If the determination in Step S10 is “No,” the control process returns to Step S5, and the recovery work is continued. If the determination in Step S10 is “Yes,” the money handling device 1 restarts the interrupted process in Step S11. The control process then returns to Step S4.

When the transfer of the banknotes is completed in the collection process described above, the determination in Step S2 is “Yes.” The interface unit 21 displays a screen through which the operator is urged to detach the collection cassette 5, as shown in FIG. 12B, for example. To detach the collection cassette 5 from the money handling device 1, the operator issues an instruction to close the shutter 56 of the collection cassette 5 through the interface unit 21 (that is to say, “detachment of the cassette”). In this case, when the collection cassette 5 is to be detached, the shutter 56 is closed. Thus, unlike the foregoing case, special authority is not required.

In Step S12, the money handling device 1 determines whether or not it has received the instruction to close the shutter 56. The money handling device 1 waits until receipt of the instruction. If the determination in Step S12 is “Yes,” the money handling device 1 closes the shutter 56 of the collection cassette 5, and unlocks the first electromagnetic lock 43 and the second electromagnetic lock 47, in Step S13. Unlocking of the door 121 allows the operator to pull the collection unit 4 out of the lower housing 12 and to handle the lever 62 of the switch 6. The operator can detach the collection cassette 5 from the base 42 in accordance with the above-described procedure. In this case, the shutter 56 of the collection cassette 5 is closed, and security is thus maintained. In addition, the banknotes do not exit from the first opening 52 of the collection cassette 5.

Even if the collection unit 4 is pulled out of the money handling device 1, the collection cassette 5 and the third transport unit 41 cannot be disconnected from each other unless the second electromagnetic lock 47 of the switch 6 is unlocked. As a result, the operator cannot detach the collection cassette 5 from the base 42. The second electromagnetic lock 47 contributes to ensuring high security of each of the collection unit 4 and the money handling device 1.

Note that in the flowchart in FIG. 11, the order of steps may be changed, some of the steps may be omitted, or a new step may be added.

The technique disclosed herein is not necessarily applied to the money handling device shown in FIG. 1 or any other figure. The technique disclosed herein is applicable to a money handling device that handles coins or a money handling device that handles both banknotes and coins. The technique disclosed herein is widely applicable to a money storage device and a money handling device each including a storage detachably mounted thereto.

What is claimed is:

1. A money storage device comprising:
a storage that stores money;
a base to which the storage is connected and that supports the storage while being connected to the storage;
a switch that switches between connection and disconnection between the storage and the base; and
a first restrictor that restricts detachment of the storage from the base with the storage connected to the base and that releases restriction of the detachment of the storage in a case where the switch disconnects the storage and the base from each other.

2. The money storage device of claim 1, wherein
the storage has a first opening through which money passes,
the base includes a transport unit that sends money to the storage through a second opening of the transport unit connected to the first opening, and
the switch switches between connection and disconnection between the first opening and the second opening.

3. The money storage device of claim 2, wherein
the transport unit sends money between the first opening and the second opening in a first direction, and
the switch switches from the connection to the disconnection by relatively moving at least one of the storage or the transport unit so that the storage and the transport unit are apart from each other in the first direction.

4. The money storage device of claim 3, wherein
the switch includes a second restrictor that restricts movement of the storage to prevent the storage and the transport unit connected to each other from being apart from each other in the first direction.

5. The money storage device of claim 4, wherein
the second restrictor includes a lock mechanism that releases restriction of the movement of the storage in a case where a signal is received from a controller.

6. The money storage device of claim 5, wherein
the second restrictor includes an engaging member that engages directly or indirectly with the storage, and a lever that disengages the engaging member, the lever being manually handled, and
the lock mechanism restricts handling of the lever, and allows handling of the lever in a case where a signal is received from the controller.

7. The money storage device of claim 1, wherein
the switch moves the storage between a first position in which the storage and the base are connected to each other and a second position in which the storage and the base are disconnected from each other, and
the first restrictor restricts the detachment of the storage from the base in a state where the storage is located in the first position, and allows the detachment of the storage from the base in a state where the storage is located in the second position.

8. The money storage device of claim 7, wherein
the first restrictor includes a cover that restricts the detachment of the storage in a closed state by covering at least one portion of the storage, and that allows the detachment of the storage in an open state by opening the storage.

9. The money storage device of claim 8, wherein
the first restrictor includes a link that links a position of the storage with opening/closing of the cover.

10. The money storage device of claim 9, wherein
the cover includes a locking portion in which the link is locked, a shift from the closed state to the open state of the cover is restricted in a state where the link is locked in the cover, and the shift from the closed state to the open state is allowed in a state where the link is not locked in the cover, and
in a case where the storage is located in the first position, the link is locked in the locking portion, and in a case where the storage has moved to the second position, the storage moving relative to the cover prevents the link from being locked in the locking portion.

11. The money storage device of claim 1 further comprising:
a third restrictor that allows the connection between the storage and the base in a case where the first restrictor restricts the detachment of the storage and that restricts the connection in a case where the first restrictor does not restrict the detachment of the storage.

12. The money storage device of claim 11, wherein
in a case where the first restrictor restricts the detachment of the storage, the third restrictor engages with the first restrictor to allow movement of the storage in a direction in which the storage is connected to the base, and in a case where the first restrictor does not restrict the detachment of the storage, the third restrictor is prevented from engaging with the first restrictor to restrict the movement of the storage.

13. A money handling device comprising:
a transport unit that transports money;
a money storage device that stores money transported by the transport unit;
a controller that outputs a control signal to the transport unit and the money storage device; and
a housing that houses the money storage device such that the money storage device can be pulled out of the housing,
the money storage device including:
a storage that stores money;
a base that is connected to the storage and supports the storage while being connected to the storage;
a switch that switches between connection and disconnection between the storage and the base; and
a restrictor that restricts detachment of the storage from the base with the storage connected to the base and that releases restriction of the detachment of the storage in a case where the switch disconnects the storage and the base from each other.

14. The money handling device of claim 13, wherein
the money storage device includes a first opening through which the money transported by the transport unit passes, a shutter that shields the first opening, a first lock that restricts pulling of the money storage device out of the housing, and a second lock that restricts switching made by the switch, and
in a case where the controller receives an instruction signal indicating detachment of the storage, the controller closes the shutter to shield the first opening, and outputs a release signal to the first lock and the second lock.

15. The money handling device of claim 14, wherein
when the money handling device recovers after occurrence of a money transport error, the controller individually receives a release instruction signal for the first lock and a release instruction signal for the second lock, outputs a release signal to the first lock upon receiving the release instruction signal for the first lock, and outputs a release signal to the second lock upon receiving the release instruction signal for the second lock.
